(19) United States
(12) Patent Application Publication
(10) Pub. No.: US 2025/0177958 A1
(43) Pub. Date: Jun. 5, 2025

(54) Iron-Ruthenium Dual Atom Catalyst and Method for Synthesizing the Same

(71) Applicant: Hong Kong Quantum AI Lab Limited, Hong Kong (HK)

(72) Inventors: Mohsen TAMTAJI, Hong Kong (HK); GuanHua CHEN, Hong Kong (HK)

(21) Appl. No.: 18/909,971

(22) Filed: Oct. 9, 2024

Related U.S. Application Data
(60) Provisional application No. 63/605,612, filed on Dec. 4, 2023.

(51) Int. Cl. B01J 23/46; B01J 21/18; B01J 23/745; B01J 35/00; B01J 35/45; B01J 35/60; B01J 37/04; B01J 37/06; B01J 37/08; B01J 37/32

(52) U.S. Cl. CPC B01J 23/462; B01J 21/18; B01J 23/745; B01J 35/19; B01J 35/45; B01J 35/60; B01J 37/04; B01J 37/06; B01J 37/08; B01J 37/32

(57) ABSTRACT

The present invention provides an iron-ruthenium dual atom catalyst (FeRu-DAC) and a method for synthesizing the same. The FeRu-DAC comprises iron-ruthenium dual-atom nano-particles dispersed in a nitrogen-doped graphene support. Each iron-ruthenium dual-atom nano-particle include a pair of iron and ruthenium atoms surrounded by four pyridinic-nitrogen atoms. The method uses a two-step pyrolysis approach. The synthesized FeRu-DAC is found to have comparable performances to platinum catalysts for oxygen reduction and evolution reaction.

### CROSS-REFERENCE TO RELATED APPLICATIONS

The present application claims priority from the U.S. Provisional Patent Application No. 63/605,612 filed Dec. 4, 2023, and the disclosure of which is incorporated herein by reference in its entirety.

### FIELD OF THE INVENTION

The present invention generally relates to dual atom catalyst (DAC). More specifically the present invention relates to synthesis method of iron-ruthenium DAC (FeRu-DAC) for rechargeable Zinc-air battery.

### BACKGROUND OF THE INVENTION

An efficient oxygen reduction and evolution reaction (ORR and OER) is required for the discharge and charge processes of rechargeable metal-air batteries. Currently, high-cost platinum catalysts (e.g., Pt/C catalysts) are mainly used for these purposes. However, the sluggish kinetics of the ORR and OER processes impose tremendous challenges, which require fundamental and experimental studies on new and low-cost catalysts. DACs, in which one metal atom usually acts as the active metal site for the electrocatalytic reaction and another metal site serves as the counterpart metal, exhibit tunable electronic structures with high electrocatalytic activities. By using the counterpart metal beside the active metal site, the electronic structure and spin state of the metal centers can be regulated toward high-performance electrochemical reactions.

Some works have been performed on the application of DACs for ORR, OER, and Zinc-air batteries. For example, regulating the spin state of Fe atoms has been studied by introducing Mn and Ni atoms as counterpart metals, leading to higher ORR activity of the Fe active site. It was then reported that the presence of counterpart Zn atoms affects the d-orbital electron distribution of Cu active sites and facilitates the cleavage of O—O and adsorption and desorption of ORR intermediates.

However, there are still unavoidable obstacles in order to synthesize DACs with optimized combinations for rechargeable Zinc-air batteries in a vast parameter space.

### SUMMARY OF THE INVENTION

In accordance with a first aspect of the present invention, an iron-ruthenium dual atom catalyst (FeRu-DAC) is provided. The FeRu-DAC comprises iron-ruthenium dual-atom nano-particles dispersed in a nitrogen-doped graphene support. Each iron-ruthenium dual-atom nano-particle include a pair of iron and ruthenium atoms. Each iron-ruthenium dual-atom nano-particle is surrounded by four pyridinic-nitrogen atoms. The nitrogen-doped graphene support is porous to enhance mass transfer of the iron-ruthenium dual-atom nano-particles.

In accordance with a second aspect of the present invention, a method for synthesizing an FeRu-DAC is provided. The method uses a two-step pyrolysis approach and comprises: dissolving an iron-based precursor and a ruthenium-based precursor in deionized water to obtain a first solution; mixing the first solution, a nitrogen precursor and a diluted graphene oxide (GO) suspension to form a second solution; freeze-drying the second solution to obtain a firstly freeze-dried product; applying a first annealing treatment on the firstly freeze-dried product to obtained a firstly annealed product; washing the firstly annealed product using sulfuric acid and ethanol; freeze-drying the firstly annealed product to obtain a secondly freeze-dried product; and applying a second annealing treatment on the secondly freeze-dried product to obtain the FeRu-DAC.

In accordance with a third aspect of the present invention, a method of using an FeRu-DAC for oxygen reduction and evolution reactions is provided. The method comprises: using iron atoms in the catalyst to act as active site for oxygen reduction and evolution reactions; using ruthenium atoms in the catalyst to act as counterparts to modify reactivity of iron atoms; and using ruthenium atoms to modify the reactivity of iron atoms by changing their electronic properties and spin state. The oxygen reduction reaction is performed in a O₂ saturated electrolyte such as 0.1 M KOH.

In accordance with a fourth aspect of the present invention, a rechargeable Zinc-air battery setup fabricated with an FeRu-DAC in place of the cathode is provided. The FeRu-DAC is loaded to the cathode of the Zinc-air battery with a loading of 0.97 mg/cm².

The synthesized FeRu-DAC is found to have comparable performances to platinum catalysts for ORR and OER. The fabricated rechargeable Zinc-air battery shows excellent performance and stability after 120 cycles.

### BRIEF DESCRIPTION OF THE DRAWINGS

Embodiments of the invention are described in more details hereinafter with reference to the drawings, in which:

FIG. 1 shows a flowchart for a method for synthesizing a FeRu-DAC in accordance with an embodiment of the present invention.

FIG. 2A shows a freeze-dried FeRu-DAC product before the pyrolysis step. FIG. 2B shows prepared blackish FeRu-DAC products after the pyrolysis step.

FIG. 3 shows wide-range X-ray photoelectron spectroscopy (XPS) spectra indicate the peaks for C 1s, N 1s, O 1s, Fe 2p, and Ru 2p.

FIG. 4 shows the N 1s high-resolution XPS spectra with four visible N species belonging to pyridinic-N (397.9 eV), Fe/Ru-N (398.6 eV), pyrrolic-N (400.0 eV), and oxidized-N (406.0 eV).

FIG. 5 shows the Fe 2p3/2 high-resolution XPS spectra of synthesized FeRu-DAC.

FIG. 6 shows the Ru 2p3/2 high-resolution XPS spectra of synthesized FeRu-DAC.

FIG. 7 shows ORR LSV of FeRu-DAC at the rotation speed of 2000 RPM and pH of 13, indicating the overpotential of 0.29 V.

FIG. 8 shows OER LSV of FeRu-DAC at pH of 13, indicating the overpotential of 0.27 V.

FIG. 9 shows ORR Tafel plot of FeRu-DAC, indicating the low Tafel slope of 104 mV/dec.

FIG. 10 shows OER Tafel plot of FeRu-DAC, indicating the low Tafel slope of 124 mV/dec.

FIG. 11 shows a photograph of the Zinc-air battery assembled using FeRu-DAC with the open-circuit voltage of 1.66 V.

FIG. 12 shows polarization curve and corresponding power density plots of Zinc-air battery assembled using FeRu-DAC for discharge and charge process, indicating the open circuit potential (OCP) of around 1.66 V.

FIG. 13 shows the galvanostatic discharge-charge curve at 1 mAcm⁻² under ambient air atmosphere for 40 hr and 120 cycles.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

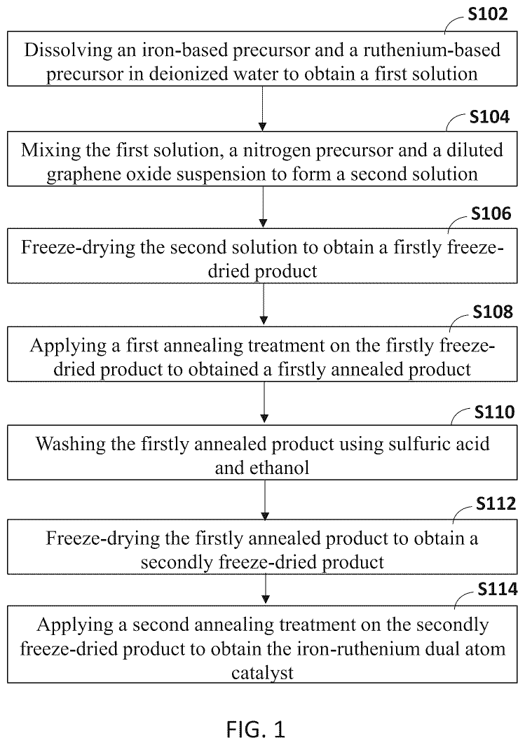

FIG. 1 shows a flowchart for a method for synthesizing a FeRu-DAC in accordance with an embodiment of the present invention.

The method comprises the following steps:
S102: dissolving an iron-based precursor and a ruthenium-based precursor in deionized water to obtain a first solution;
S104: mixing the first solution, a nitrogen precursor and a diluted GO suspension to form a second solution;
S106: freeze-drying the second solution to obtain a firstly freeze-dried product;
S108: applying a first annealing treatment on the firstly freeze-dried product to obtained a firstly annealed product;
S110: washing the firstly annealed product using sulfuric acid and ethanol;
S112: freeze-drying the firstly annealed product to obtain a secondly freeze-dried product;
S114: applying a second annealing treatment on the secondly freeze-dried product to obtain the iron-ruthenium dual atom catalyst.

The iron-based precursor may be selected from, but not limited to, FeCl₃·6H₂O, FeCl₂·4H₂O and FeSO₄·7H₂O salts. The ruthenium-based precursor may be selected from, but not limited to, RuCl₃·xH₂O salt. The nitrogen precursor may be selected from, but not limited to, acrylamides and 2-Methylimidazole.

In some embodiments, the first annealing treatment is performed in a temperature range of 425° C.˜475° C. (preferably at 450° C.) for 3 hours under Ar atmosphere. The second annealing treatment is performed in a temperature range of 570° C.˜610° C. (preferably at 590° C.) for 3 hours under Ar atmosphere.

In some embodiments, the diluted GO suspension may be prepared by: dispersing expanded graphite into H₂SO₄ to obtain a first suspension; stirring the first suspension in an ice bath for 2 hours; adding KMnO₄ to the first suspension to form a second suspension; stirring the second suspension at room temperature for 4 hours until the second suspension to obtain a GO suspension; and diluting the GO suspension with deionized water to form the diluted GO suspension.

The synthesized FeRu-DAC may comprise iron-ruthenium dual-atom nano-particles highly dispersed (or evenly distributed) in a nitrogen-doped graphene support. Each iron-ruthenium dual-atom nano-particle includes a pair of iron and ruthenium atoms. Each iron-ruthenium dual-atom nano-particle is surrounded by four pyridinic-nitrogen atoms. The nitrogen-doped graphene support is porous to enhance mass transfer of the iron-ruthenium dual-atom nano-particles.

### Exemplary Synthesis of GO

GO is synthesized using a modified hummers method through the exfoliation and oxidation of expanded graphite sheets during thermal treatment. Briefly, microwave-expanded graphite (1 g) is dispersed into 30 ml of H₂SO₄ (98%) inside a 500 ml round bottom flask, followed by stirring in an ice bath. After 2 hours, KMnO₄ (5 g) is slowly added to the suspension and the suspension is kept stirring at room temperature for 4 hours until the color becomes pale brownish. Subsequently, the solution is diluted slowly with 50 ml of deionized water while the color is converted into brown. After that, the solution is diluted with 200 ml of deionized water while stirring for another 2 hours at room temperature. Then, enough amount of H₂O₂ (30 wt. %) is added dropwise to the solution mixture to reduce the residual KMnO₄ until the solution's color changes towards bright green. Then the solution is stirred for 2 hours and was allowed to settle for 1 day. The synthesized GO is then centrifuged and washed at least 10 times with deionized water at 15000 RPM for 30 min. Finally, the centrifuged GO solution is reached to 8 mg/ml concentration by dispersing into deionized water.

### Exemplary Synthesis of FeRu-DAC Catalyst

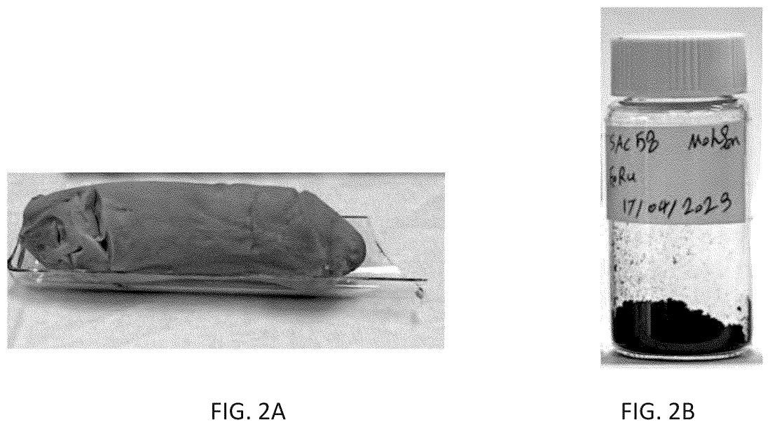

To synthesize FeRu-DAC, FeCl₃·6H₂O and RuCl₃·xH₂O salts are dissolved to make 0.05 M solutions of Fe³⁺ and Ru³⁺, respectively. GO suspension is diluted by mixing 12.5 ml of 8 mg/ml GO into 120 ml of deionized water. 125 μl of 0.05 M of Fe³⁺ and Ru³⁺ solutions and 1.2 ml of acrylamides (25 wt. %, as the nitrogen precursor) are added into the diluted GO suspension and stirred for 40 hours. The mixed solution is freeze-dried for 4 days and went through a two-step annealing process, as follows, to synthesize a highly dispersed catalyst. The brownish freeze-dried product (FIG. 2A) went through the first annealing step in a 1-inch quartz tube furnace at 450° C. for 3 hours under Ar (200 sccm). Then the blackish product is washed using H₂SO₄ (0.05 M) and ethanol (96%) 5 times before being freeze-dried. Subsequently, the freeze-dried product went through the second annealing process at 590° C. for 3 hours under Ar (200 sccm) to produce a blackish FeRu-DAC product (FIG. 2B).

### Characterization of FeRu-DAC Catalyst

The synthesized FeRu-DAC was examined by XPS with a PHI 5000 VersaProbe III (ULVAC-PHI). All XPS spectra were corrected concerning the C 1s peak (284.48 eV).

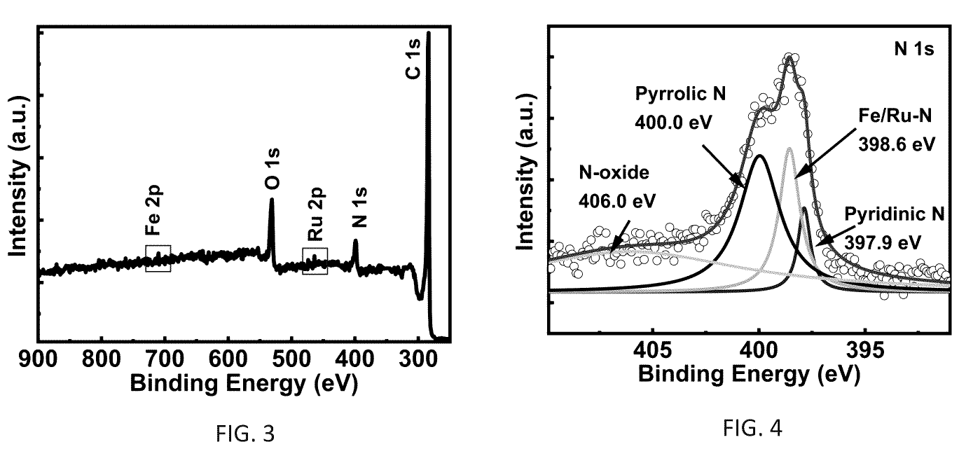

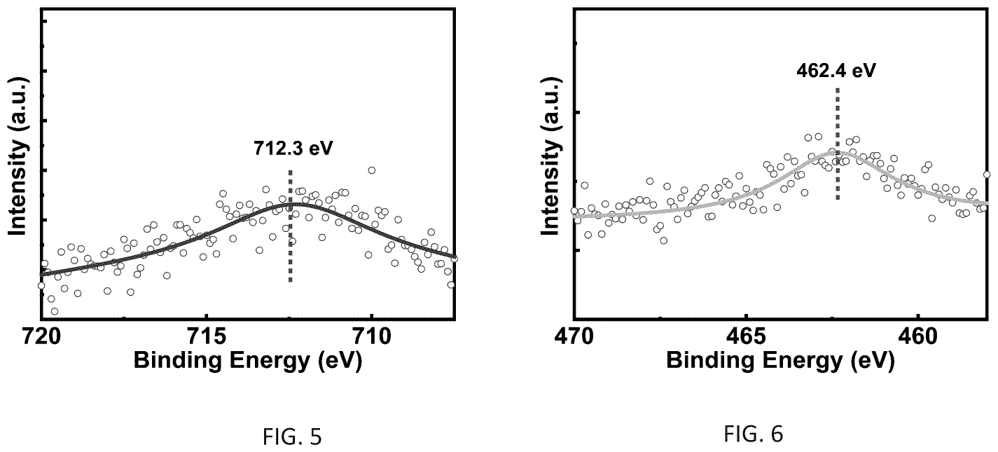

The XPS results show the Fe and Ru metal contents are 0.30 and 0.32 wt. %, respectively, in the FeRu-DAC. This suggests the Fe/Ru molar ratio of around 1:1. FIG. 3 shows the wide-range XPS spectra indicating the peaks for C 1s, N 1s, O 1s, Fe 2p, and Ru 2p. We deconvoluted the N 1s peak, suggesting different types of nitrogen atoms for the synthesized FeRu-DAC. FIG. 4 shows that the N 1s peak for FeRu-DAC can be deconvoluted into pyridinic-N (397.9 eV), Fe/Ru-N (398.6 eV), pyrrolic-N (400.0 eV), and oxidized-N (406.0 eV). FIG. 5 and FIG. 6 show a high-resolution peak spectrum, respectively, for Fe and Ru metals of the synthesized FeRu-DAC, indicating a valence state of 2p_{3/2} for Fe and Ru with partially oxidative states.

### Electrocatalytic Activity of FeRu-DAC Catalyst

The ORR and OER tests were performed by taking 2.5 mg of each of FeRu-DAC products, 350 μl of deionized water, 150 ml of ethyl alcohol, and 50 μL of Nafion (5 wt. % in a mixture of lower aliphatic alcohols and water). The mixture was sonicated for 1 day to get a homogeneous black ink of the catalyst. Then, 3 droplets of 10 μL of the ink was dropped on the neat and clean surface of a glassy carbon electrode (GCE) with a diameter of 0.5 cm and a surface area of 0.196 cm². Therefore, the loading for the as-prepared catalyst is 0.695 mg/cm².

We used a three-electrode cell loaded with 0.1 M KOH aqueous electrolyte (pH=13) for both ORR as well as OER performance measurements. The GCE loaded with the FeRu-DAC catalyst was used as a working electrode, Pt wire was used as a counter electrode, and an Ag/AgCl electrode was used as a reference electrode. The reversible hydrogen electrode (RHE) potentials were then obtained from E_{RHE}=E_{Ag/AgCl}+0.197+0.0592×pH. Highly pure Ar (99.99%) and O₂ (99.99%) were purged to the electrolyte (0.1 M KOH) for 40 min before testing our catalyst. The linear sweep voltammetry (LSV) tests were performed from positive to negative potentials with a scan rate of 10 mVs⁻¹ and step size of 5 mV. The rotating speed was set to 2000 RPM and 0 RPM for ORR and OER, respectively. To obtain Tafel slopes for ORR and OER, applied potential is plotted versus logarithmic scale current density which is obtained from corresponding LSV polarization curves.

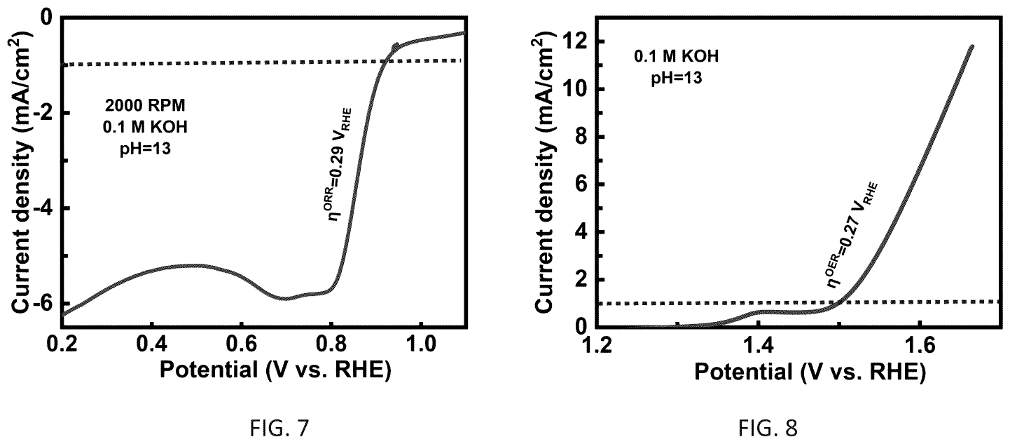

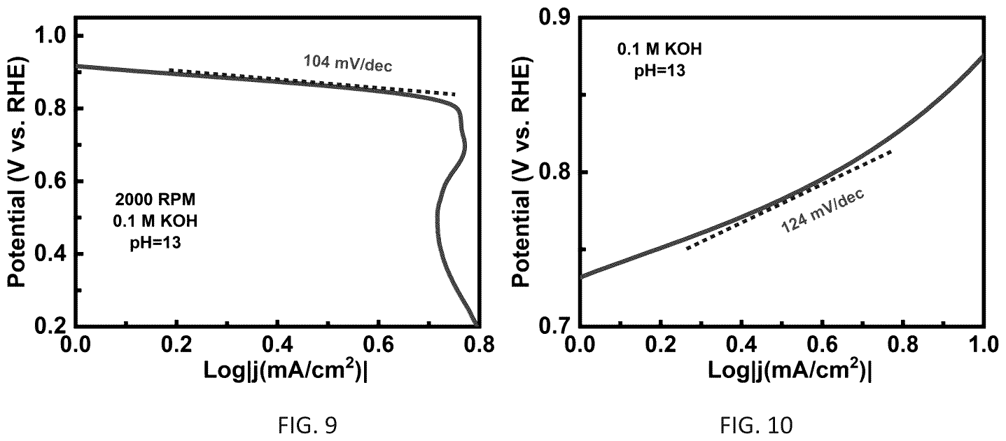

The ORR and OER performances were taken using a rotating ring disk electrode device (RRDE-3A, ALS Co.). FIG. 7 and FIG. 8 show the ORR and OER linear sweep volumetry (LSV) of FeRu-DAC for the rotation speed of 2000 RPM. The ORR and OER reduction currents appear at +0.94 V_{RHE} and 1.50 V_{RHE}, respectively, corresponding to very low ORR and OER overpotentials of 0.29 V and 0.27 V. The ORR and OER performances of as-synthesized catalyst are judged through Tafel slope values resulting from corresponding current-density curves. As shown in FIG. 9 and FIG. 10, the FeRu-DAC delivered low Tafel slopes of 104 mVdec⁻¹ and 124 mVdec⁻¹ for ORR and OER, respectively, suggesting that the FeRu-DAC has favorable reaction kinetics for both discharge and charge processes of rechargeable Zinc-air batteries.

### Exemplary Zinc-Air Battery Setup With FeRu-DAC

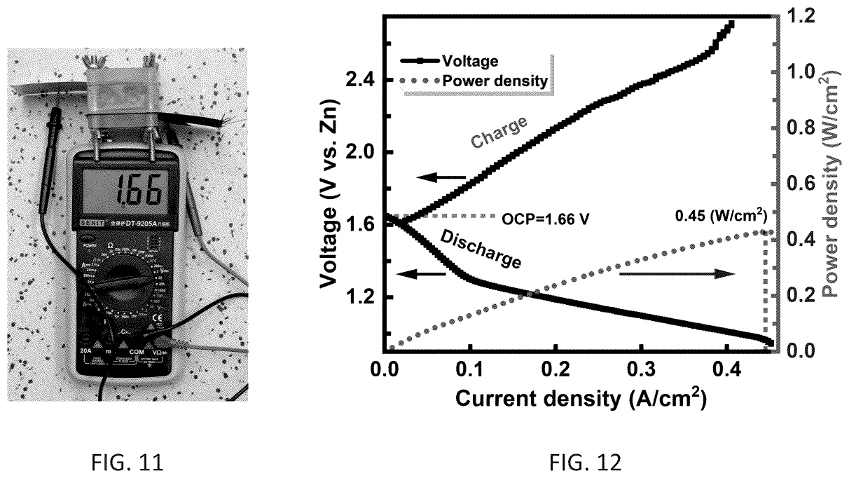

59 mg of FeRu-DAC, 563 μl of deionized water, 563 ml of ethyl alcohol, and 375 μL of Nafion (5 wt. % in a mixture of propanol and water) were taken and the mixture was mixed for 15 minutes to get a homogeneous black ink of the catalyst. Subsequently, the as-prepared black ink was coated on the carbon cloth with a height of 260 μm and was dried out overnight in an oven at the temperature of 50° C. leading to the catalyst loading of 0.97 mg/cm². After that, the carbon cloth loaded with the catalyst was used as the cathode, a Zinc plate with a thickness of 1 mm was used as the anode, and the Zinc-air cell was filled with 6 M KOH as the electrolyte. FIG. 11 demonstrates the photograph of the Zinc-air battery assembled with FeRu-DAC with an open-circuit voltage of 1.66 V.

### Performance of Zinc-Air Battery Setup

Polarization curves were measured at room temperature on a Gamry 5000E workstation to obtain voltage and power density versus current. FIG. 12 shows discharge and charge polarization curves and corresponding discharge power density plots of the Zinc-air battery, indicating the open circuit potential (OCP) of 1.66 V versus Zinc. This indicated that the FeRu-DAC can give a maximum power density of 0.45 W/cm² at the current density of 0.44 A/cm².

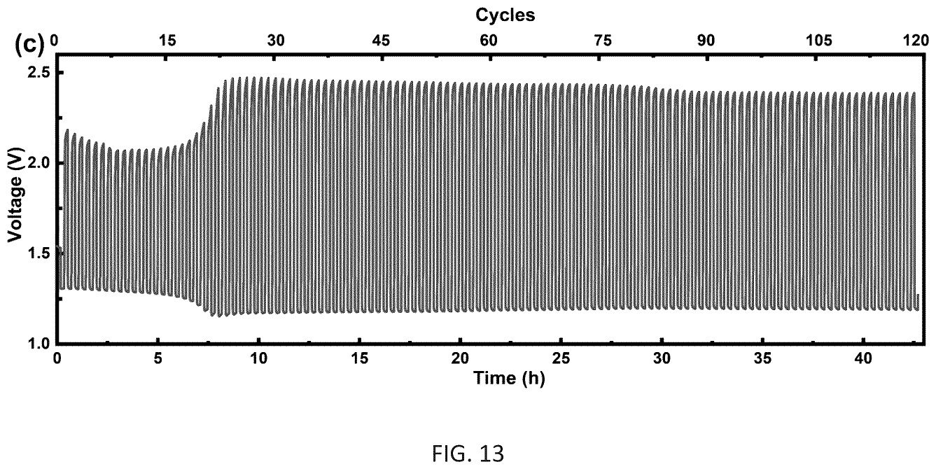

The galvanostatic discharge-charge curve was obtained on Land Battery Test System CT3001A (Wuhan Land Electronic). FIG. 13 shows the galvanostatic discharge-charge plot of the Zinc-air battery for 40 hr (120 cycles) at the current density of 1 mAcm⁻², under ambient air atmosphere, and 6M KOH is used as the electrolyte. This indicates the stability of the catalyst for 120 discharge-charge cycles. Each charge and discharge process were set to 10 min in duration, following by 1 min duration for relaxation. The discharge and charge potentials reach 1.2 V and 2.4 V, respectively, leading to a 1.2 V gap between the discharge and charge potentials.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. An iron-ruthenium dual atom catalyst, comprising iron-ruthenium dual-atom nano-particles dispersed in a nitrogen-doped graphene support.

2. The dual atom catalyst according to claim 1, wherein each iron-ruthenium dual-atom nano-particle include a pair of iron and ruthenium atoms.

3. The dual atom catalyst according to claim 2, wherein each iron-ruthenium dual-atom nano-particle is surrounded by four pyridinic-nitrogen atoms.

4. The dual atom catalyst according to claim 3, wherein the nitrogen-doped graphene support is porous to enhance mass transfer of the iron-ruthenium dual-atom nano-particles.

5. A method for synthesizing an iron-ruthenium dual atom catalyst of claim 1, comprising:
dissolving an iron-based precursor and a ruthenium-based precursor in deionized water to obtain a first solution;
mixing the first solution, a nitrogen precursor and a diluted graphene oxide suspension to form a second solution;
freeze-drying the second solution to obtain a firstly freeze-dried product;
applying a first annealing treatment on the firstly freeze-dried product to obtained a firstly annealed product;
washing the firstly annealed product using sulfuric acid and ethanol;
freeze-drying the firstly annealed product to obtain a secondly freeze-dried product; and
applying a second annealing treatment on the secondly freeze-dried product to obtain the iron-ruthenium dual atom catalyst.

6. The method according to claim 5, wherein the diluted graphene oxide suspension is prepared by:
dispersing expanded graphite into H₂SO₄ to obtain a first suspension;
stirring the first suspension in an ice bath for 2 hours;
adding KMnO₄ to the first suspension to form a second suspension;
stirring the second suspension at room temperature for 4 hours until the second suspension to obtain a graphene oxide suspension; and
diluting the graphene oxide suspension with deionized water to form the diluted graphene oxide suspension.

7. The method according to claim 5, wherein the iron-based precursor is a FeCl₃·6H₂O salt, a FeCl₂·4H₂O salt or a FeSO₄·7H₂O salt.

8. The method according to claim 5, wherein ruthenium-based precursor is a RuCl₃·xH₂O salt.

9. The method according to claim 5, wherein the nitrogen precursor is an acrylamide or a 2-Methylimidazole.

10. The method according to claim 5, wherein the first annealing treatment is performed in a temperature range of 425° C.˜475° C. for 3 hours under Ar atmosphere.

11. The method according to claim 5, wherein the second annealing treatment is performed in a temperature range of 570° C.˜610° C. for 3 hours under Ar atmosphere.

12. A method of using an iron-ruthenium dual atom catalyst of claim 1 for oxygen reduction and evolution reactions, comprising:
using iron atoms in the catalyst to act as active site for oxygen reduction and evolution reactions;
using ruthenium atoms in the catalyst to act as counterparts to modify reactivity of iron atoms; and
using ruthenium atoms to modify the reactivity of iron atoms by changing their electronic properties and spin state.

13. The method according to claim 12, wherein the oxygen reduction reaction is performed in a O₂ saturated electrolyte.

14. The method according to claim 13, wherein the O₂ saturated electrolyte is a 0.1 M KOH solution.

15. The method according to claim 12, further comprising loading the iron-ruthenium dual atom catalyst to a cathode of a Zinc-air battery with a loading of 0.97 mg/cm².
